(19) United States
(12) Patent Application Publication
(10) Pub. No.: US 2008/0078121 A1
(43) Pub. Date: Apr. 3, 2008

(54) Combined planter and flag holder adjustably and detachably secured to tree or pole

(76) Inventor: Richard Stanio, Enfield, CT (US)

Correspondence Address: Donald W. Meeker;Patent Agent, 924 East Ocean Front #E, Newport Beach, CA, 92661, US

(21) Appl. No.: 11/529,894

(22) Filed: Sep. 29, 2006

(51) Int. Cl. A01G 9/02

(52) U.S. Cl. 47/67

(57) ABSTRACT

A planter is removably and adjustably attached to a base bracket mounted on a tree trunk or pole for vertically pivoting to match the angle of the tree trunk. A flag on a dowel or rod is inserted into a cylindrical groove on the bottom of the planter or alternately on the bottom of the base bracket. In one embodiment, two curved wing planter sections may be removably and adjustably attached to the planter to pivot horizontally, compensating for the diameter of the tree trunk or pole.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to planters and particularly to a combined planter and flag or banner holder adjustably and detachably secured to a tree trunk or pole by a system comprising a bracket attached to the tree or pole, a planter which slides onto the bracket and adjusts through a vertical angle on the bracket to compensate for the tilt of a tree with a flag attached to the planter.

2. Description of Related Art Including Information Disclosed Under 37 CFR 1.97 and 1.98

Many property owners use flower containers and flags or banners to beautify their landscaped properties. In recent years, decorative flags have become popular and are seen in an assortment of themes, such as seasonal, holiday, or represent a property owner's personal interest or hobbies.

Plant growing receptacles and flag holders which are mounted to trees or poles are known, however not in a combined device which is adjustable to the tree or pole diameter and slant.

U.S. Pat. No. 6,752,279, issued Jun. 22, 2004 to Dwyer, indicates a device for attaching at least one flower pot to a tree trunk. At least one flower pot holder holds the at least one flower pot, respectively. A strap engages the at least one flower pot holder and attaches the at least one flower pot holder to the tree trunk. A skirt is an elongated sheet of material that engages the at least one flower pot holder and wraps around the tree trunk. Each flower pot holder is a continuous rod bent into a vertical portion and a horizontal portion. The vertical portion is U-shaped and abuts against the tree trunk. The horizontal portion has a neck that extends perpendicularly outwardly and continuously from the vertical portion and a head that is ring-shaped and extends coplanarly outwardly and continuously from, and is wider than, the neck and holds one flower pot.

U.S. Pat. No. 5,966,865, issued Oct. 19, 1999 to Jones, puts forth an attachment apparatus for supporting a flower holder module on a cylindrical support and includes a module holder portion. A transverse bridge member includes a proximal end which is connected to a bottom portion of the module holder portion. A strap support member is connected to a distal end of the bridge member. The strap support member includes a first strap reception channel. A first flexible strap is threaded through the first strap reception channel. A first fastener assembly is connected to the first flexible strap. The strap support member further includes a second strap reception channel located above the first strap reception channel. A second flexible strap is threaded through the second strap reception channel, and a second fastener assembly is connected to the second flexible strap. Each of the first fastener assembly and the second fastener assembly includes an inside hook-or-loop material located on an inside surface of the respective flexible strap and includes a complimentary loop-or-hook material on an outside surface of the respective flexible strap. In addition, each of the first flexible strap and the second flexible strap can include a quantity of relatively high friction rubber material on a respective inside strap surface. Each of the first flexible strap and the second flexible strap is wrapped around the cylindrical support, and the hook-or-loop material is attached to the complimentary loop-or-hook material to secure the attachment apparatus to the cylindrical support.

U.S. Patent Application #20040006913, published Jan. 15, 2004 by Jordan, is for a hug-a-tree planter, which comprises a system for supporting potted plants and other items around a support column. The system provides a secure method for displaying items such as potted plants in non-traditional places. A support belt that has nodes on its interior side is wrapped around a support column, such as a tree or pole, so that the nodes make contact with the support column. Items such as plants are supported around the column by special pots with hooks. The hooks slide into the gap created between the support column and the belt, by the nodes. A connecting device is used to secure opposite ends of the belt together and create sufficient inward pressure on and friction against the support column as to support multiple pots.

U.S. Pat. No. 6,269,589, issued Aug. 7, 2001 to Bouler, describes a planter capable of attachment on a vertical surface to a tree trunk or utility pole. The planter comprises at least one segment having an arcuate inside wall to conform to the central tree trunk or pole. Each segment extends partially around the circumference of the tree or pole. Segments may be interconnected using any one of four alternative fasteners: the first fastener is a resilient cable wrapped around a tree trunk with each segment having a pair of hooks to attach it to the cable; the second fastener interconnects segments using a pair of latches having holes therethrough with a bolt that is secured through the holes; the third fastener also interconnects segments by each segment having a pair of pins extending from the outer wall and near the end walls with a gasket having complementary holes securing the segments; and the fourth fastening means interconnects the segments using interlocking female and male edges.

U.S. Pat. No. D210,302, issued Feb. 27, 1968 to Lansford, is for the ornamental design of a device for supporting a plurality of plant pots around the trunk of a tree.

U.S. Pat. No. 5,292,014, issued Mar. 8, 1994 to Lelong, discloses a tensile support device comprising a pair of rigid, elongated members which are horizontally disposed and attached closely together at their outer ends and held widely spaced apart by a cable or strap at their inner ends which rest against a supporting surface, such as a wall, a tree, a pole, or a plurality of balcony posts. A tensional support cable is fastened at its lower end to the outer ends of the members or to the connection between the outer ends of the members and at its upper end to the supporting surface, or to a window sill by using an auxiliary bracket, at a point substantially above the inner ends, whereby a compressive force is created along the rigid members when a plant container is hooked over the connection between the outer ends.

U.S. Pat. No. 6,708,832, issued Mar. 23, 2004 to Hannon, provides a device for hanging objects on a vertical support. The hanging device includes a girding member having first and second sides. The first side of the girding member has a pair of spaced nubs projecting therefrom which defines a gap. A first support member includes a first end having a portion pivotably receivable in the gap and a second end. A second support member extends between the first support member and the vertical support.

U.S. Pat. No. 5,259,141, issued Nov. 9, 1993 to D'Alessandro, shows a planter for supporting a plurality of plant pots around the trunk of a tree, which comprises a plurality of identical, flat segments, each segment forming the arc of a circle having an opening in the middle to support a flower pot. A pair of arcuate slots are located on opposite sides of the opening, the segments overlapping each other with the arcuate slots on overlapping segments being aligned with each other and surrounding the trunk. A bolt extends through each pair of aligned slots held together by a wing nut which are locked together after sliding said overlapping segments with respect to each other to closely fit the outline of the trunk. The segments can be designed to accommodate a pole with a rectangular cross section.

U.S. Pat. No. D369,123, issued Apr. 23, 1996 to D'Alessandro, claims the ornamental design for a tree planter, which is similar to U.S. Pat. No. 5,259,141

U.S. Pat. No. D386,114, issued Nov. 11, 1997 to Carson, shows the ornamental design for a tree collar planter.

U.S. Pat. No. 585,486, issued Jun. 29, 1897 to Snow, illustrates a vase combined with a flag holder, which is mounted on a stake.

U.S. Pat. No. 3,920,207, issued Nov. 18, 1975 to Adamaitis, is for a flag holder that is detachably secured to a tree trunk or a pole by two straps.

What is needed is a combined planter and flag holder device that has a base bracket attached to a tree or pole and a back groove that slides onto the base bracket to that it attaches easily to a tree or pole and is stable and easily removable, which device adjusts to the slant of the tree trunk or pole and in one embodiment, to the diameter of the tree.

### BRIEF SUMMARY OF THE INVENTION

An object of the present invention is to provide a combined planter and flag holder that has a base bracket attached to a tree or pole and a back horizontal groove that slides onto the base bracket to that it attaches easily to a tree or pole and is stable and easily removable.

An added object of the present invention is to provide horizontally pivotable wing planter sections in a combined planter and flag holder that can adjust to the diameter of any tree or pole.

An ensuing object of the present invention is to provide a combined planter and flag holder with a series of spaced vertical holes in the base bracket that receive a pin from the center planter section to pivot the center planter section vertically to adjust to the slant of any tree trunk.

One more object of the present invention is to provide bottom horizontal cylindrical groove in the center planter section and a dowel or rod in the top channel of a flag making it simple and convenient to change the flag in the flag holder.

An additional object of the present invention is to provide removable planter trays with holes in the bottom that drop into the open cavity of each of the planter sections to leave space and the bottom of the planter for the water to seep through the bottom holes so that the water saturates the soil.

A contributory object of the present invention is to provide slots in the bottoms of the removable planter trays as an integrated means of drainage for a planter.

An ancillary object of the present invention is to provide three slidably interlocking planter sections so that the combined planter and flag holder is easy to assemble and disassemble.

In brief, a base bracket attaches to a tree or pole. The back of a center planter section is shaped with an extending attaching portion having an open horizontal groove to accept the base by sliding the center planter section onto the base from left to right or vise versa to attach the center planter section to the tree. The top and bottom edges of the groove overlay the base to prevent the center planter section from being pulled forward and taken off. Instead you would have to slide it all the way to the left or right.

The top of the attaching portion has a horizontal slot extending into the groove. The base bracket has a series of spaced holes extending from a curved front surface in a vertical array over a curved top surface so that a pin is insertable through the slot into one of the holes to adjust for the slant of the tree trunk and secure the center planter section at a desired vertical angle relative to the tree trunk, preferably with the center planter section horizontal. The pin can move horizontally in the slot, allowing for lateral adjustment of the center planter section.

A vertical cylindrical open-sided slot on each side of the center planter section receives a vertical cylindrical end of a wing planter section. A circular array of spaced protrusions in the bottom of each cylindrical slot interacts adjustably with a mating circular array of spaced protrusions in the bottom of the cylindrical end of a wing planter section to allow the wing planter sections to pivot horizontally relative to the center planter section to adjust for the diameter of the tree or pole and to lock each of the wing planter sections at a desired horizontal angle relative to the center planter section, preferably with each wing planter section contacting the tree trunk or pole. The vertical cylindrical end of each of the planter wing sections is inserted into the open top of one of the vertical cylindrical open-sided vertical slot on each side of the center planter section and the side edges of the open-sided vertical slot keeps the wing planter sections from being pulled off. They can only be taken off by lifting them up and out of the center planter section.

Each of the three main planter sections (the center planter section and two wing planter sections) has a tray that fits into an open top of each of the planter sections. These trays will be placed into the planter sections before filling them with dirt for planting. The trays have slots on the bottom which sits up over the planter's bottom to allow water (which comes in from the slots on each front piece or water from above) to soak the dirt and therefore keep the soil watered longer.

The bottom of the center planter section has a horizontal cylindrical slot with an open bottom slot along its length so that a flag with a rod through a looped end of the flag slides into the horizontal cylindrical slot with the flag hanging down through the open bottom slot.

An advantage of the present invention is that it provides a combined planter and flag holder device that attaches easily to a tree or a pole.

Another advantage of the present invention is that it provides an easily removable combined planter and flag holder.

An added advantage of the present invention is that it provides a combined planter and flag holder that can adjust to the diameter of any tree or pole.

An ensuing advantage of the present invention is that it provides a combined planter and flag holder that can adjust to the slant of any tree trunk.

One more advantage of the present invention is that it provides a simple and convenient way to change the flag in a flag holder.

A further advantage of the present invention is that it provides a simple and stable way to suspend a planter.

A contributory advantage of the present invention is that it provides an integrated means of drainage for a planter.

An ancillary advantage of the present invention is that it provides a combined planter and flag holder that is easy to assemble and disassemble.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view showing the assembled components of the combined planter and flag of the present invention attached to a tree trunk;

FIG. 2 is a perspective view showing the components of the combined planter and flag of FIG. 1 aligned for assembly;

FIG. 3 is a top plan view showing the assembled components of the combined planter and flag of FIG. 1 attached to a tree trunk;

FIG. 4 is a bottom perspective view showing the components of the combined planter and flag of FIG. 1 aligned for assembly;

FIG. 5 is a perspective view showing the center planter section and base bracket of the present invention;

FIG. 6 is a perspective view of an alternate embodiment of the combined planter and flag of the present invention showing the flag and planter aligned for assembly;

FIG. 7 is a perspective view of the embodiment of the invention of FIG. 6 showing the assembled components of the combined planter and flag of the present invention attached to a tree trunk;

FIG. 8 is a side elevational view of the embodiment of the invention of FIG. 6 showing the assembled components of the combined planter and flag of the present invention attached to a tree trunk;

FIG. 9 is a perspective view of the embodiment of FIG. 6 showing the main planter and base bracket of the present invention;

FIG. 10 is a perspective view of the base bracket of the present invention mounted on a tree with the planter removed and the flag alternately inserted in the horizontal cylindrical groove of the base bracket.

### DETAILED DESCRIPTION OF THE INVENTION

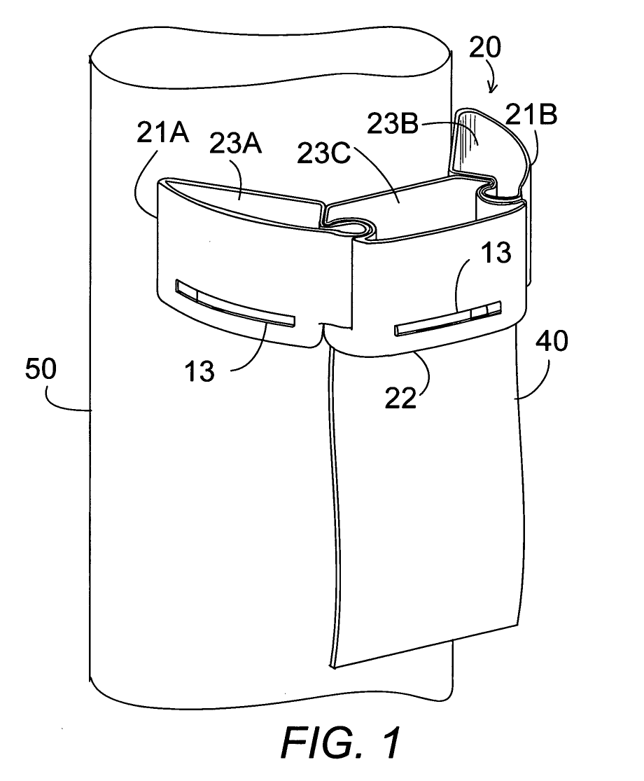

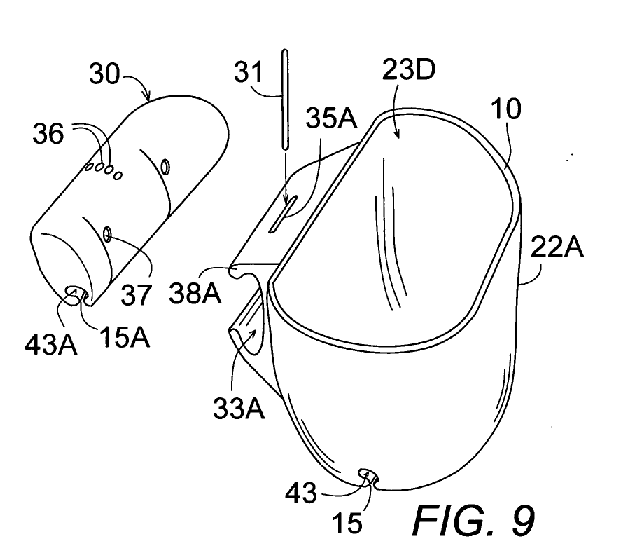

In FIGS. 1-10, a combined planter and flag holder device 20 and 20A removably attaches to a tree trunk 50 or pole or other upright structure.

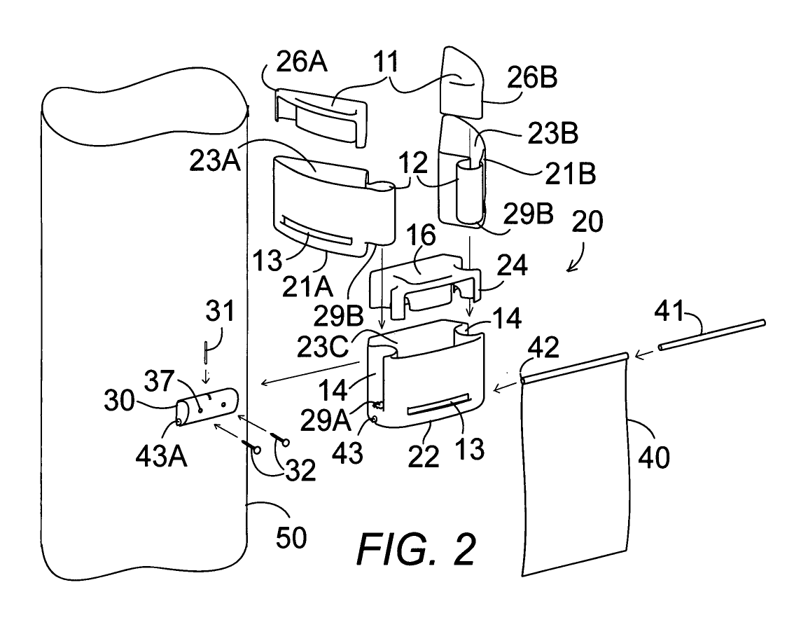

In FIGS. 2, 4, 5, 8, and 9, an elongated base bracket 30 is attached horizontally by nails or screws 32 through holes 37 to a tree trunk 50 or vertical pole or other upright surface. The base bracket is made of a rigid material that has a curved front surface contiguous with a curved top, and has a series of adjustment holes 36 that extend vertically in a spaced array from the curved front surface over the curved top surface for receiving a planter 22 and 22A attached to the base bracket with a pin 31 alternately positioned in a different adjustment hole 36 with the pin between the base bracket and the planter, so that the planter pivots vertically and locks onto one of the adjustment holes 36 to adjust for a vertical tilt of the tree trunk or other upright surface.

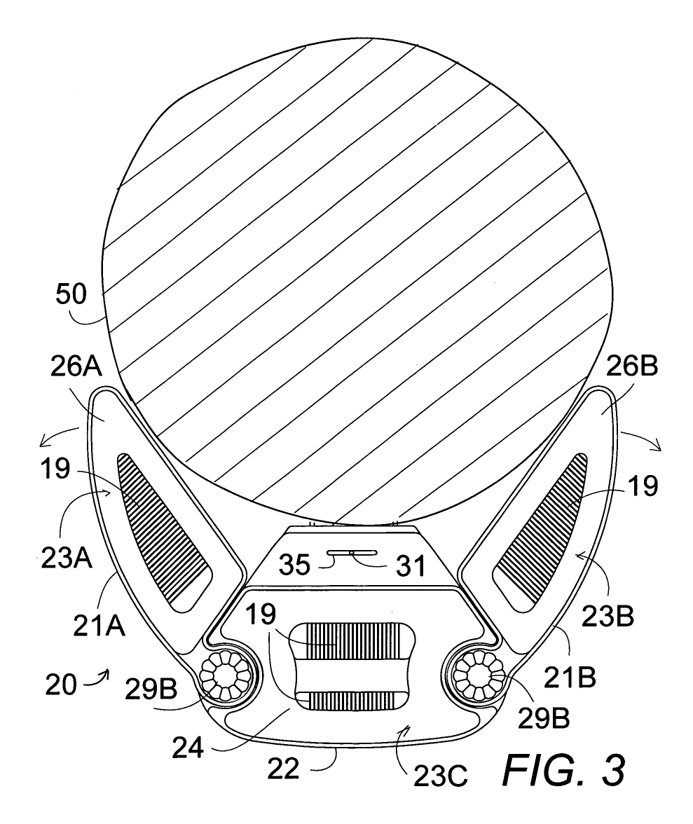

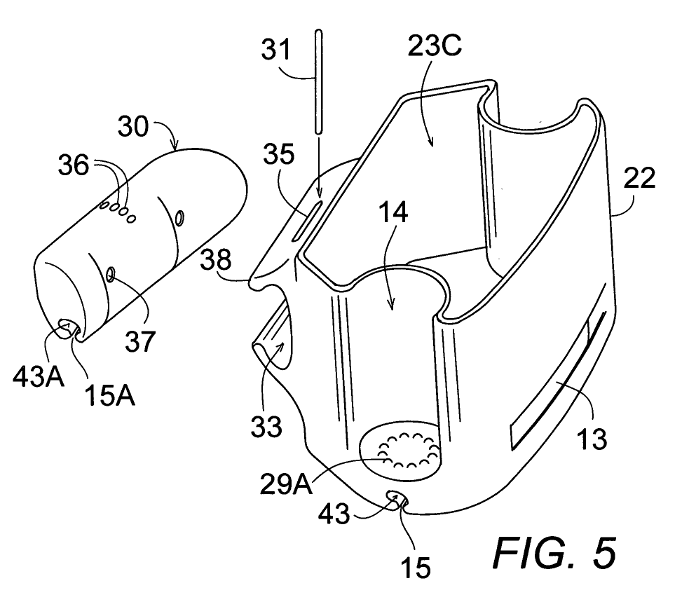

In FIGS. 1-5, a first embodiment of the invention has a center planter section 22, which has a bottom surface, a peripheral wall and an open interior 23C accessible through an open top, and which attaches to the base bracket 30 by an attaching portion 38 that extends from the back of the center planter section. In FIG. 5, The attaching portion has a horizontal groove 33 with a back open horizontal slot 35 along the length of the groove. The horizontal groove 33 is configured to accept the base bracket 30 by sliding the center planter section 22 onto the base bracket (previously attached to a tree trunk or other upright surface) from a side of the base bracket, thereby attaching the center planter section to the tree trunk 50 or vertical pole or other upright structure. The top of the attaching portion 38 has a horizontal slot 35 that communicates with the horizontal groove 33. An elongated rigid pin 31 inserted through the horizontal slot 35 in the attaching portion and into one of the series of spaced openings 36 in the base bracket secures the center planter section 22 at a desired vertical angle relative to the tree trunk or vertical pole to adjust for any slant in the tree trunk or pole, and allow horizontal sliding of the center planter section relative to the base bracket with the pin 31 moving in the horizontal slot 35 of the attaching portion 38, as shown in FIG. 3.

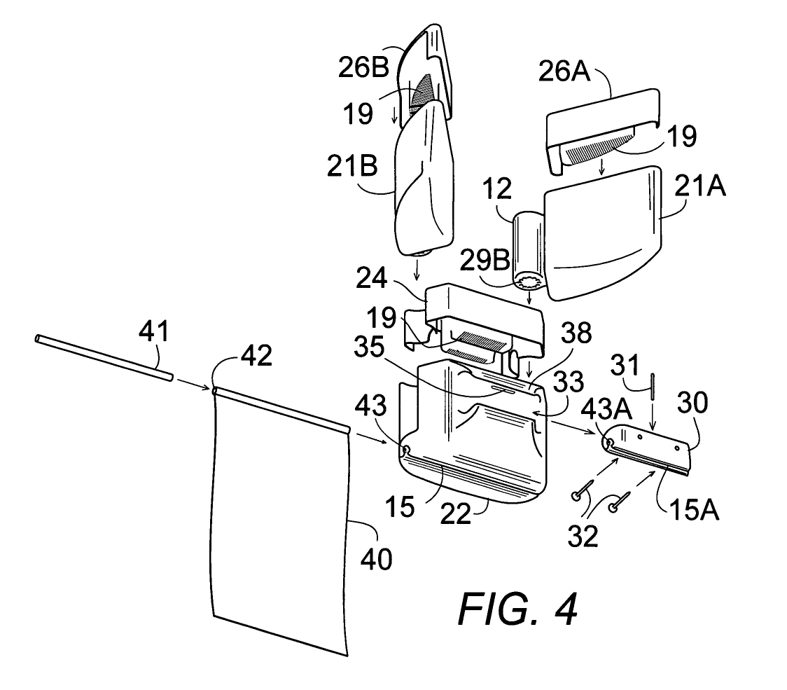

In FIGS. 2, 4, and 5, the center planter section 22 has a vertical cylindrical groove 14 on each side of the center planter section. Each vertical cylindrical groove has an open-sided vertical slot and a circular array of spaced protrusions 29A on a bottom surface of the cylindrical groove. A bottom extension to the center planter section has a horizontal cylindrical slot 43 therethrough with an open bottom slot along its length, as shown in FIG. 4.

In FIGS. 2 and 4, a pair of wing planter sections 21A and 21B each has a bottom, a peripheral wall, an open interior 23A and 23B accessible through an open top, and a vertical cylindrical end extension 12 at one end of the wing planter section. The vertical cylindrical end extension has a circular array of spaced protrusions 29B on an exterior bottom surface of each vertical cylindrical end extension, as shown in FIG. 4. The spaced protrusions 29B mate with the circular array of spaced protrusions 29A on the bottom of the cylindrical groove 14 of the center planter section 22, as shown in FIGS. 2 and 5, when the vertical cylindrical end extension 12 of one of the planter wing sections is inserted into the open top of one of the vertical cylindrical grooves 14 of the center planter section. The wing planter sections 21A and 21B can be pivotally adjusted in horizontal angle to compensate for tree trunk or pole diameter before the two circular arrays of spaced protrusions 29A and 29B are mutually engaged to lock the wing planter sections in a desired horizontal angle relative to the center planter section 22, as shown by the arrows in FIG. 3.

In FIG. 2, trays 26A, 26B, and 24 are inserted into the open interiors 23A, 23B, and 23C of each of the planter sections. Each of the trays has at least one cavity 11 and 16 with an open top that holds soil for planting and a bottom with slots 19 for water in the bottom of the planter section to saturate the soil through the slots.

In FIGS. 2 and 4 a flag 40 has a looped end channel 42 of the flag and a dowel or rod 41 inserted within the looped end channel. The looped end channel of the flag with the rod is inserted into the horizontal cylindrical groove 43 with the flag hanging down through the open bottom slot 15 as shown in FIG. 1.

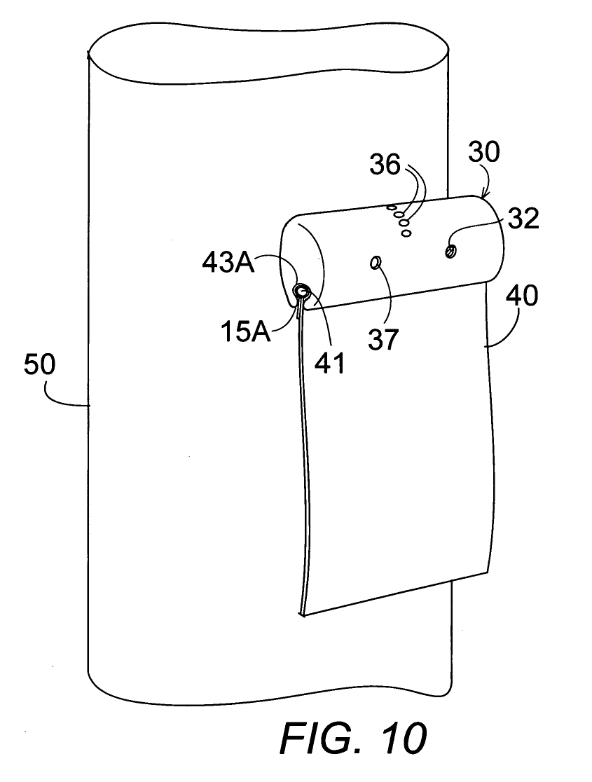

In FIGS. 2, 4-5, and 8-10, the elongated base bracket 30 may further comprise a bottom base bracket extension having a horizontal base bracket cylindrical slot 43A therethrough with an open bottom base bracket slot 15A along its length with at least one base bracket slot opening at an end of the horizontal base bracket slot, wherein with the main planter removed from the base bracket, the flag 40 and rod 41 are alternately removably insertable into the at least one base bracket end opening of the horizontal base bracket cylindrical groove 43A with the flag hanging down through the open bottom base bracket slot 15A as shown in FIG. 10.

In FIGS. 1, 2, and 5, each of the planter sections may have a horizontal slot 13 on an outside face communicating with the tray inside the planter section for water to pass through the horizontal slot for overflow.

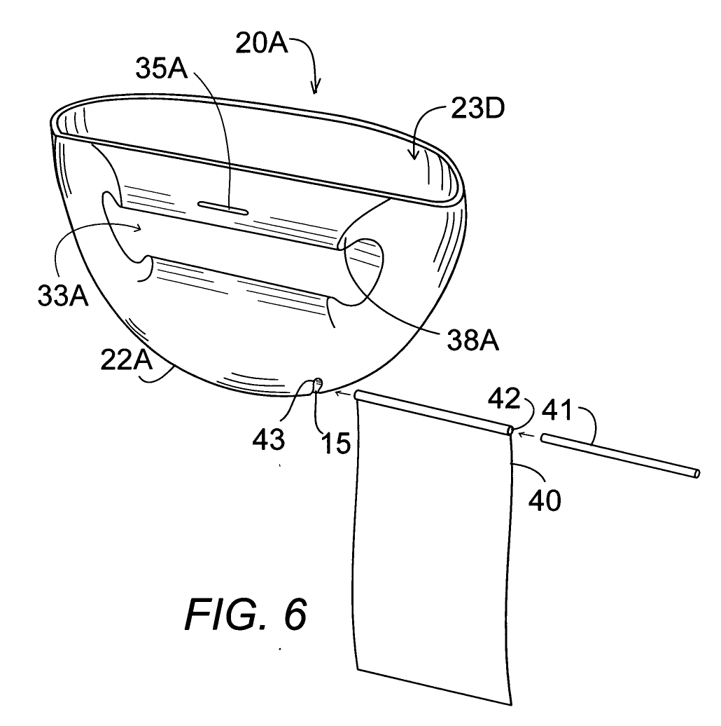

In FIGS. 6-9 a second embodiment of the invention 20A comprises a single main planter section 22A with as internal planter space 23D having a top opening to receive a plant therein. In FIGS. 6, 8, and 9, a back attaching portion 38A has a horizontal groove 33A with a back open horizontal slot along the length of the groove. The horizontal groove 33A is configured to accept the base bracket 30 by sliding the main planter 22A onto the base bracket (previously attached to a tree trunk or other upright surface) from a side of the base bracket, thereby attaching the main planter 22A to the tree trunk 50 or vertical pole or other upright structure. The top of the attaching portion 38A has a horizontal slot 35A that communicates with the horizontal groove 33A. An elongated rigid pin 31 inserted through the horizontal slot 35A in the attaching portion and into one of the series of spaced openings 36 in the base bracket secures the center planter section 22A at a desired vertical angle relative to the tree trunk or vertical pole to adjust for any slant in the tree trunk or pole, and allow horizontal sliding of the center planter section relative to the base bracket with the pin 31 moving in the horizontal slot 35A of the attaching portion 38A.

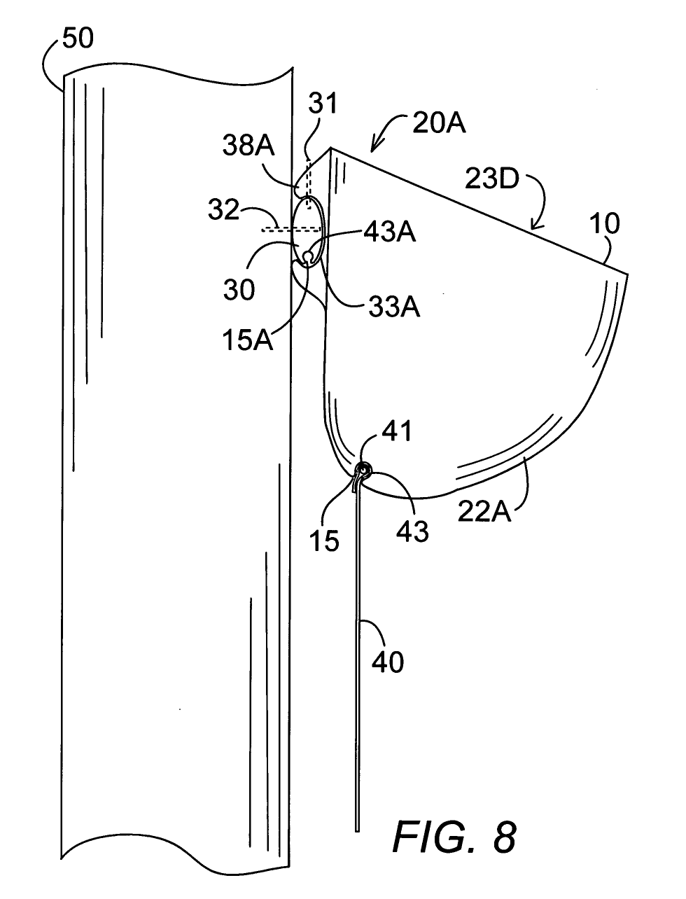

The main planter 22A has a downwardly angled top lip 10 so that the open cavity is more easily accessible for installing and caring for a plant in the main planter and for viewing the plant, as shown in FIG. 8.

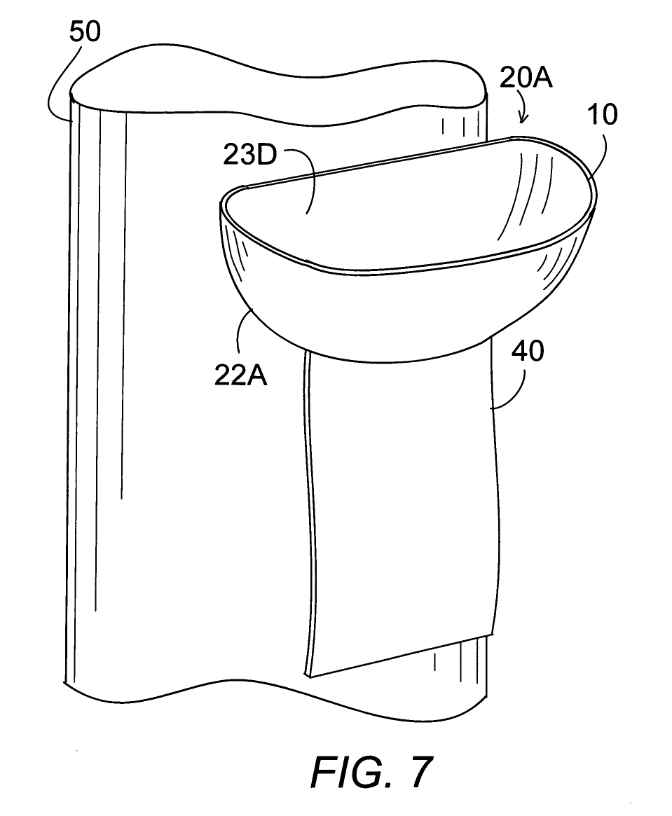

A flag 40 has a looped end channel 42 of the flag and a dowel or rod 41 inserted within the looped end channel 42. The looped end channel of the flag with the rod is inserted into the horizontal cylindrical groove 43 having open ends to receive the looped top of the flag and rod therein and narrow bottom ridges to retain the looped end of the flag and rod therein with the flag hanging down through the open bottom slot 15 as shown in FIGS. 7 and 8 forming a combined planter and flag attachable to a tree trunk or other upright surface so that the back surface of the planter adjusts to a tilt in a tree trunk or other upright surface so that the back surface rests against the tree trunk or other upright surface and the flag hangs down from the planter.

As indicated in the first embodiment, in the second embodiment of FIGS. 6-9, the elongated base bracket 30 may further comprise a bottom base bracket extension having a horizontal base bracket cylindrical slot 43A therethrough with an open bottom base bracket slot 15A along its length with at least one base bracket slot opening at an end of the horizontal base bracket slot, wherein with the main planter removed from the base bracket, the flag 40 and rod 41 are alternately removably insertable into the at least one base bracket end opening of the horizontal base bracket cylindrical groove 43A with the flag hanging down through the open bottom base bracket slot 15A as shown in FIG. 10.

All the parts of the combined planter and flag holder device 20 and 20A, exclusive of the mounting screws 32 and the elongated pin 31, which may be metal, are fabricated of molded plastic structured to fit together to form the combined planter and flag holder that attaches to a tree trunk or pole.

In use, the base bracket 30 is nailed or screwed onto a tree trunk 50 or pole or other upright surface using mounting nails or screws 32. A center planter section 22 or main planter 22A is attached to the base bracket by sliding a horizontal groove 33 and 33A onto the mating curved surface of the base bracket 30. The center planter section 22 or main planter 22A is then secured by dropping an elongated pin 31 through a horizontal slot 35 and 35A on the top of the curved groove in the back of the center planter section and into any of a series of vertically spaced holes 36 in the base bracket 30. The different holes allow for vertical angular adjustment of the center planter section 22 or main planter 22A, compensating for the angle or slant of the tree trunk or other upright surface and achieving the desired angle of the planter device. The horizontal slot 35 and 35A allows for lateral movement to level the planter.

In the first embodiment 20, two wing planter sections 21A and 21B slide into cylindrical grooves 14 on the sides of the center section 22 and pivot front to back to adapt to different diameters of tree trunk or pole. Three removable trays 26A, 26B, and 24 are filled with soil and plants and set into the open cavities 23A, 23B, and 23C of each of the three planter sections.

In both embodiments, a flag 40 on a dowel or rod 41 is inserted into a cylindrical groove 43 on the bottom of the center planter section 22 or main planter 22A. With the planter removed, the flag 40 and rod 41 are alternately removably insertable into the base bracket end opening of the horizontal base bracket cylindrical groove 43A with the flag hanging down through the open bottom base bracket slot 15A as shown in FIG. 10. The planters can be watered and changed as desired.

It is understood that the preceding description is given merely by way of illustration and not in limitation of the invention and that various modifications may be made thereto without departing from the spirit of the invention as claimed.

### Sequence Listing

Not Applicable.

What is claimed is:

1. A combined planter and flag holder device attachable to a tree or pole, the device comprising in combination:
an elongated base bracket attached horizontally to a tree trunk or vertical pole, the base bracket comprising a rigid element having a curved front surface contiguous with a curved top, the base bracket having a series of adjustment holes extending vertically in a spaced array from the curved front surface over the curved top surface;
a main planter section comprising a bottom, a peripheral wall and an open interior accessible through an open top, and an attaching portion extending from a back side of the main planter section, the attaching portion having a horizontal groove with a back open horizontal slot along the length of the groove, the horizontal groove configured to accept the base bracket by sliding the main planter section onto the base bracket from a side of the base bracket to attach the main planter section to the tree trunk or vertical pole, the attaching portion having a horizontal slot along a top of the attaching portion, the slot communicating with the horizontal groove, and the main planter section further comprising a bottom planter extension having a horizontal planter cylindrical slot therethrough with an open bottom planter slot along its length with at least one planter slot opening at an end of the horizontal planter slot;
an elongated rigid pin inserted through the horizontal slot in the attaching portion and into one of the series of spaced openings in the base bracket to secure the main planter section at a desired vertical angle relative to the tree trunk or vertical pole to adjust for any slant in the tree trunk or pole, and allow horizontal sliding of the main planter section relative to the base bracket with the pin moving in the horizontal slot of the attaching portion;
a flag having a looped end of the flag and a rod inserted within the looped end and the looped end of the flag and rod removably insertable into the at least one planter end opening and the horizontal planter cylindrical groove with the flag hanging down through the open bottom planter slot for a combined planter and flag attachable to a tree trunk or other upright surface so that the back surface of the planter adjusts to a tilt in a tree trunk or other upright surface so that the back surface rests against the tree trunk or other upright surface and the flag hangs down from the planter.

2. The device of claim 1 wherein the elongated base bracket further comprises a bottom base bracket extension having a horizontal base bracket cylindrical slot therethrough with an open bottom base bracket slot along its length with at least one base bracket slot opening at an end of the horizontal base bracket slot, wherein with the main planter removed from the base bracket, the flag and rod are alternately removably insertable into the at least one base bracket end opening of the horizontal base bracket cylindrical groove with the flag hanging down through the open bottom base bracket slot.

3. The device of claim 1 wherein the main planter has a downwardly angled top lip so that the open cavity is more easily accessible for installing and caring for a plant in the main planter and for viewing the plant.

4. A combined planter and flag holder device attachable to a tree or pole, the device comprising in combination:
an elongated base bracket attached horizontally to a tree trunk or vertical pole, the base bracket comprising a rigid element having a curved front surface contiguous with a curved top, the base bracket having a series of adjustment holes extending vertically in a spaced array from the curved front surface over the curved top surface;
a center planter section comprising a bottom, a peripheral wall and an open interior accessible through an open top, and an attaching portion extending from a back side of the center planter section, the attaching portion having a horizontal groove with a back open horizontal slot along the length of the groove, the horizontal groove configured to accept the base bracket by sliding the center planter section onto the base bracket from a side of the base bracket to attach the center planter section to the tree trunk or vertical pole, the attaching portion having a horizontal slot along a top of the attaching portion, the slot communicating with the horizontal groove, the center planter section further comprising a vertical cylindrical groove on each side of the center planter section, each vertical cylindrical groove having an open-sided vertical slot and a circular array of spaced protrusions on a bottom surface of the cylindrical groove, and the center planter section further comprising a bottom planter extension having a horizontal cylindrical planter slot therethrough with an open bottom planter slot along its length with at least one planter slot opening at an end of the horizontal planter slot;
an elongated rigid pin inserted through the horizontal slot in the attaching portion and into one of the series of spaced openings in the base bracket to secure the center planter section at a desired vertical angle relative to the tree trunk or vertical pole to adjust for any slant in the tree trunk or pole, and allow horizontal sliding of the center planter section relative to the base bracket with the pin moving in the horizontal slot of the attaching portion;
a pair of wing planter sections, each comprising a bottom, a peripheral wall and an open interior accessible through an open top, and a vertical cylindrical end extension at one end of the wing planter section, the vertical cylindrical end extension having a circular array of spaced protrusions on an exterior bottom surface of each vertical cylindrical end extension to mate with the circular array of spaced protrusions on a bottom surface of the cylindrical groove, the vertical cylindrical end of each of the planter wing sections being inserted into the open top of one of the vertical cylindrical grooves and adjusted in horizontal angle to adjust for tree trunk or pole diameter and the two circular arrays of spaced protrusions mutually engaged to lock the wing in a desired horizontal angle relative to the center planter section;
a tray inserted into an open top of each of the planter sections, each of the trays having at least one cavity having an open top for receiving dirt therein for planting and a bottom having slots therethrough for drainage of water; and
a flag having a looped end of the flag and a rod inserted within the looped end and the looped end of the flag and rod removably insertable into the at least one planter end opening and the horizontal planter cylindrical groove with the flag hanging down through the open bottom planter slot for a combined planter and flag attachable to a tree trunk or other upright surface so that the back surface of the planter adjusts to a tilt in a tree trunk or other upright surface so that the back surface rests against the tree trunk or other upright surface and the flag hangs down from the planter.

5. The combination device of claim 4 wherein each of the planter sections has a horizontal slot on an outside face communicating with the tray inside the planter section for water to pass through the horizontal slot.

6. The device of claim 4 wherein the elongated base bracket further comprises a bottom base bracket extension having a horizontal base bracket cylindrical slot therethrough with an open bottom base bracket slot along its length with at least one base bracket slot opening at an end of the horizontal base bracket slot, wherein with the center planter removed from the base bracket, the flag and rod are alternately removably insertable into the at least one base bracket end opening of the horizontal base bracket cylindrical groove with the flag hanging down through the open bottom base bracket slot.
